(19) United States
(12) Patent Application Publication
(10) Pub. No.: US 2012/0228421 A1
(43) Pub. Date: Sep. 13, 2012

(54) MOVABLE NEEDLE WINDING HEAD FOR A WINDING MACHINE

(76) Inventor: Kevin D. Heffelfinger, Hicksville, OH (US)

(21) Appl. No.: 13/415,489

(22) Filed: Mar. 8, 2012

Related U.S. Application Data
(63) Continuation of application No. PCT/US2010/048064, filed on Sep. 8, 2010.
(60) Provisional application No. 61/240,460, filed on Sep. 8, 2009.

(51) Int. Cl. H02K 15/085

(52) U.S. Cl. 242/432.5

(57) ABSTRACT

An in-slot winding machine for winding a winding of a stator includes a winding head including at least one movable needle which is positionable between a retracted position and an extended position, the retracted position being oriented generally axially relative to a longitudinal axis of the winding head, the extended position being oriented generally radially relative to the longitudinal axis.

### CROSS REFERENCE TO RELATED APPLICATIONS

This is a continuation of PCT application No. PCT/US2010/048064, entitled “MOVABLE NEEDLE WINDING HEAD FOR A WINDING MACHINE”, filed Sep. 8, 2010, which claimed priority to U.S. provisional patent application Ser. No. 61/240,460, entitled “MOVABLE NEEDLE WINDING HEAD FOR A WINDING MACHINE”, filed Sep. 8, 2009, which is incorporated herein by reference.

### BACKGROUND OF THE INVENTION

1. Field of the Invention

The present invention relates to winding machines for electric motors, and, more particularly, to movable needles in winding heads for use in such winding machines.

2. Description of the Related Art

In typical dynamoelectric machines, such as an electric motor, generator, alternator, or the like, the stator assembly includes a generally cylindrical stack of laminations made from a magnetic material having a plurality of axially extending slots formed in the internal bore thereof. Electrical coils, or more specifically the side turn portions of electrical coils, are disposed within the slots in various configurations to produce a desired magnetic field for operation of the device.

Winding machines for producing wire coils for dynoelectric machines may be of two basic configurations. One type of winding machine is known as a “form winder” and another type is known as an “in-slot winder”.

One type of form winder, known as a shed winder, provides a non-rotating shed form on which wire coils are wound by a rotating flyer. A wire supply spool is located at one end of the flyer feed system and a shed form is provided at the other end. The coils wound on the shed form are “shed” or moved to transfer tooling or inserter tooling positioned at the free end of the shed form.

With an in-slot winder, the winding head and its wire-dispensing member, or needle, are moved in a compound reciprocating high-speed stroke which is sequentially parallel to and then transverse to the axis of the stator bore to thereby place a winding around the stator poles or teeth.

Many types of specialized motors utilize stator cores of relatively small size with a relatively large number of teeth extending radially inward to define a central stator bore which is small in cross-section. The teeth may be straight sided and the slot area between the radial teeth is, therefore, of circular sector configuration. In order to provide a maximum number of turns on each tooth, it is, thus, desirable to place windings on the teeth which are of varying depth—that is, varying from a minimum depth at the free, inner end of each tooth to a maximum at the base of the tooth. The circular sector configuration of the space between teeth is thereby utilized to maximum effectiveness.

The placing of such varying depth windings appears, using conventional stator winding technology, to require the imposing of a further radial movement on the winding head in addition to the sequential angular and vertical reciprocating motion necessary to produce the conventional winding. The additional radial motion imposed must, to make the matter still more complicated, be composed of a series of strokes of varying or identical magnitude. Various apparatus have been attempted utilizing complicated dwell gearing to provide the required added radial motion to the wire-dispensing member component of the winding head. Other apparatus have attempted to solve the problem by bodily shifting the winding head and its wire-feeding shaft in a sequenced, orbital, circular path; but this mode of operation is inhibited by the relatively small central bore of the stators being wound and the relatively long stator teeth.

Some in-slot winders also use movable needles to vary the winding depth around each stator tooth. One type of movable needle pivots at its proximal end such that the distal end moves in a general direction along the axis of the stator. During axial movement of the winding head, this type of pivoting motion of the needle causes the tip of the needle to be shifted further into the stator slot at one end of the axial movement, and out of the stator slot at the other end of the axial movement.

What is needed in the art is a winding head with a plurality of movable needles, the needles being able to wind coils both at the base of respective stator teeth and at the free end of the respective stator teeth when the stator has a small inside diameter (ID).

### SUMMARY OF THE INVENTION

The present invention provides a movable needle for a winding head, the needle transitioning from generally axial motion to generally radial motion relative to a longitudinal axis of the winding head.

The invention in one form is directed to an in-slot winding machine for winding a winding of a stator. The winding machine includes a winding head including at least one movable needle which is positionable between a retracted position and an extended position, the retracted position being oriented generally axially relative to a longitudinal axis of the winding head, the extended position being oriented generally radially relative to the longitudinal axis.

The invention in another form is directed to a winding head of an in-slot winding machine for winding a winding of a stator. The winding head includes at least one movable needle which is positionable between a retracted position and an extended position, the retracted position being oriented generally axially relative to a longitudinal axis of the winding head, the extended position being oriented generally radially relative to the longitudinal axis.

The invention in yet another form is directed to a method of using a winding machine for winding a winding of a stator, the method including: providing a winding head including at least one movable needle; and positioning the at least one movable needle between a retracted position and an extended position, the retracted position being oriented generally axially relative to a longitudinal axis of the winding head, the extended position being oriented generally radially relative to the longitudinal axis.

An advantage of the present invention is that it provides a movable needle for a winding head which is movable and transitions from generally axial motion to generally radial motion, relative to a longitudinal axis of the winding head. This allows the use of single or multiple movable needles in winding a stator with a small ID.

Another advantage is that it provides a winding head with a diameter of less than one inch.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side, sectional view of a winding machine including a winding head according to the present invention, one of the three moveable needles of the winding head being shown in the retracted position;

FIG. 2 is a sectional view of winding head of FIG. 1 within a small ID stator, the three moveable needles being in the retracted position;

FIG. 3 is a side, cross-sectional view of the winding machine including the winding head of FIG. 1, one of the three moveable needles of the winding head being shown in the extended position;

FIG. 4 is a sectional view of winding head of FIG. 3 within a small ID stator, the three moveable needles being in the extended position;

FIG. 5 is a side view of the needle of FIG. 1 and a wing of the center tree, the needle being shown in the retracted position, in the extended position, and in three intermediate positions between the retracted and extended positions;

FIG. 6 is a top view of the needle of FIG. 1;

FIG. 7 is an exploded view of the winding head of FIG. 1; and

FIG. 8 is a top view of the center tree of the winding head according to the present invention.

Corresponding reference characters indicate corresponding parts throughout the several views. The exemplifications set out herein illustrate one embodiment of the invention, and such exemplifications are not to be construed as limiting the scope of the invention in any manner.

### DETAILED DESCRIPTION OF THE INVENTION

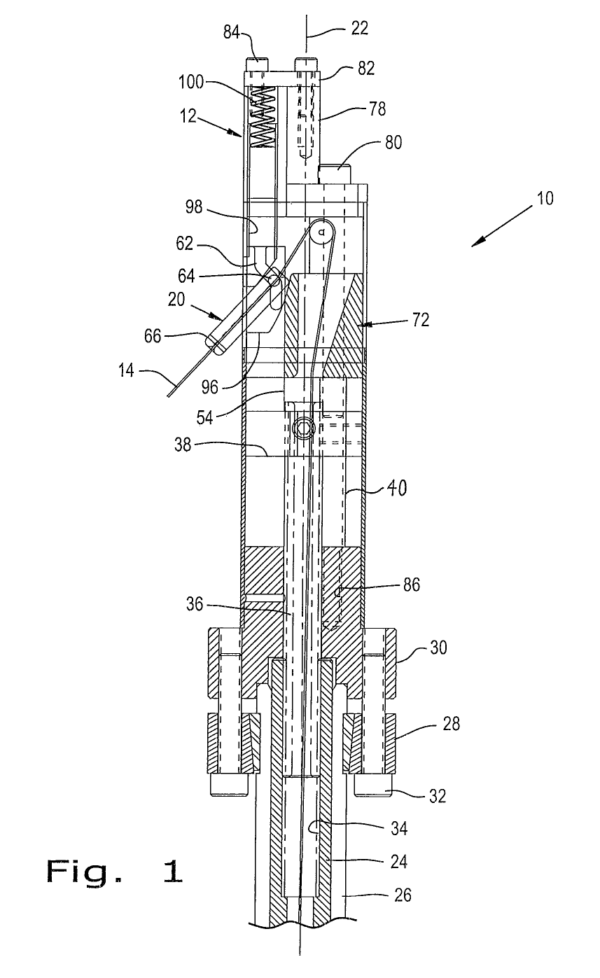

Referring now to the drawings, and more particularly to FIGS. 1-4, there is shown a portion of an in-slot winding machine 10 which generally includes a winding head 12. Winding machine 10 winds an electrically conductive winding 14 (such as copper wire 14) of a stator 16 and uses winding head 12 to do so. Winding 14 can include at least one copper wire 14 wound around at least one tooth 18 of stator 16. The embodiment of the present invention which is shown in the drawings shows that winding 14 includes three copper wires 14 being wound onto three stator teeth 18 simultaneously, the three wires 14 corresponding to three needles 20. Other portions of winding machine 10 hold stator 16 in place as winding head 12 winds winding 14 on teeth 18 of stator 16. Winding machine 10 is configured for moving winding head 12 to provide up to 1200 turns per minute. Winding head 12 advantageously can have three needles 20 and have a diameter which is less than one inch (such as in the vicinity of needles 20).

The function of winding head 12 is to move single or multiple winding needle(s) 20 a distance that is longer than is normally capable in a normal winding head, especially when constrained by a small ID stator 16. In a normal winding head, when the needle(s) are retracted to the ID of the winding head, the needle(s) will interfere with each other and/or the wire path, thereby restricting the distance that the needle(s) will travel. In winding head 12 of the present invention, needles 20 retract and at the same time the back (the proximal end) of needles 12 travel up to eliminate the interference of needles with each other and/or with the path of wires 14.

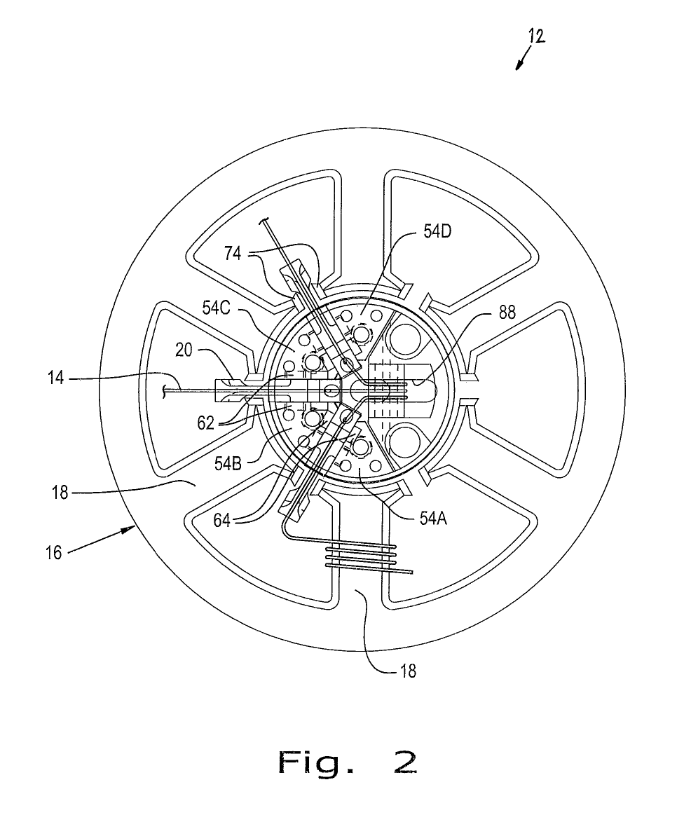

FIGS. 1 and 2 show needle 20 of winding head 12 in a fully retracted position 66.

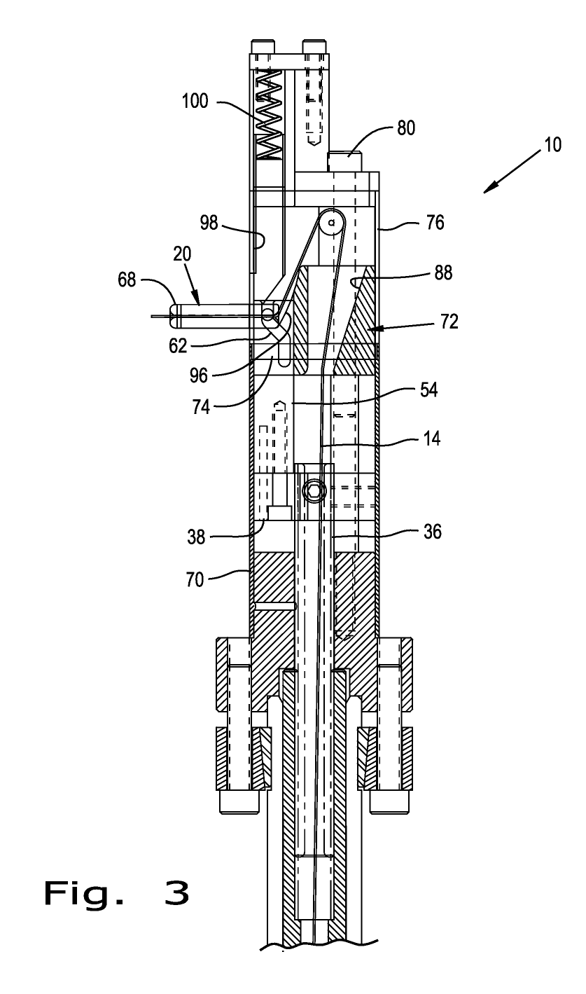

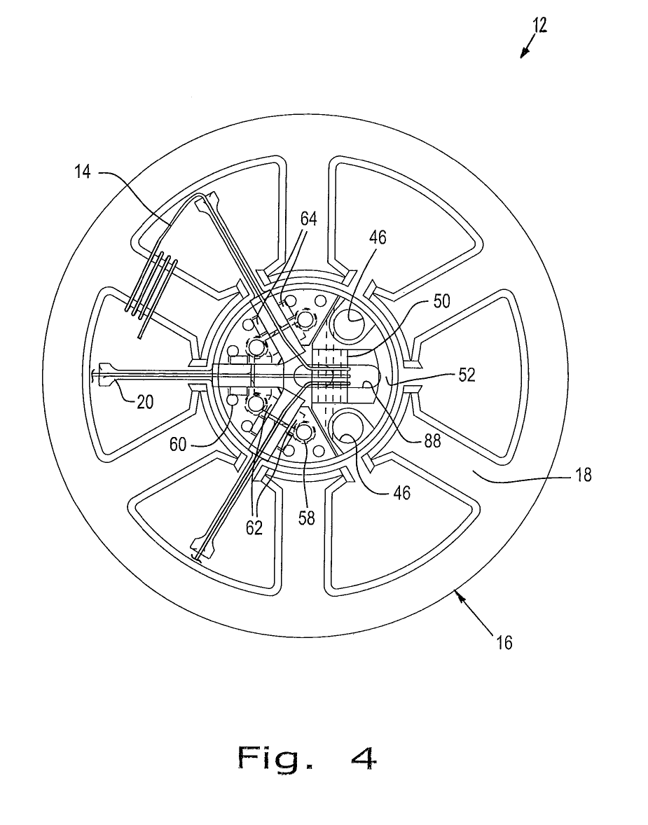

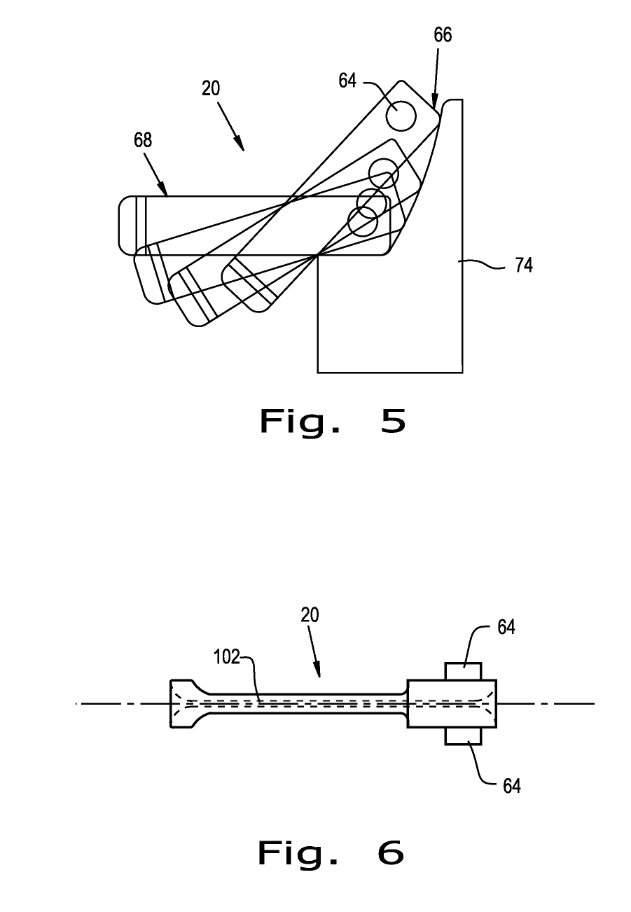

FIGS. 3 and 4 shows needle 20 in a fully extended position 68. FIGS. 2 and 4 show winding head 12 including three needles 20 according to the present invention, FIGS. 1 and 3 showing only one such needle 20 for illustrative purposes. FIGS. 2 and 4 show cross-sectional views looking downward onto winding head taken along a plane which is perpendicular to the page of FIGS. 1 and 3, the cross-sectional plane being taken between a top surface of roller assembly 48 (described below) and a bottom surface of spring housing cap 78 (described below); FIGS. 2 and 4, however, omit keeper 98 (described below). FIG. 5 illustrates the full travel of needle 20, in increments. Winding head 12 of the present invention generally includes a longitudinal axis 22, an inner shaft 24, a threaded shaft 36, a plate 38, a cam system 54, a lower sleeve 70, an upper sleeve 76, a spring housing cap 78, an upper cap 82, posts 40, a center tree 72, a roller assembly, a biased keeper 98, and at least one movable needle 20.

Inner shaft 24 is positioned within a spline shaft 26 of winding machine 10, spline shaft 26 being attached to a fixed collar clamp 28 of winding machine, collar clamp 28 being bolted to a fixed base 30 of winding head 12 using at least two bolts 32. Inner shaft 24 includes a bore 34 which is at least partially threaded. Bore 34 at least partly receives threaded shaft 36. Inner shaft 24 is configured for rotating within spline shaft 26 during operation of winding head 12, spline shaft 26 being stationary. Inner shaft 24 is driven to rotate by an intermitter oscillator (not shown). Bore 34 of inner shaft 24 also passes the three wires 14 of winding 14 therethrough (three wires 14 being used when three needles 20 are used). For illustrative purposes, only one such wire 14 is shown in FIGS. 1 and 3. Three wires 14, however, are shown in FIGS. 2 and 4.

Threaded shaft 36 is positioned within inner shaft 24. Threaded shaft 36 includes an outer surface with threads and a longitudinally extending through-bore. Threads of threaded shaft 36 are thereby threadably received by corresponding threads of bore 34 of inner shaft 24. As inner shaft 24 rotates in one direction, the threaded connection between inner shaft 24 and threaded shaft 36 causes threaded shaft 36 to travel up, as shown in FIG. 1. As inner shaft 24 rotates in the opposite direction, the threaded connection between inner shaft 24 and threaded shaft 36 causes threaded shaft 36 to travel down, as shown in FIG. 3. Threaded shaft 36 does not rotate within inner shaft 24. Rather, threaded shaft 36 is prevented from rotating within inner shaft 24 by way of plate 38 and two posts 40. Threaded shaft 36 extends from inner shaft 24 into a bore of base 30 and then out through a top side of base 30. The upper end of threaded shaft 36 is threadably and fixedly attached to a bore 42 of plate 38 of winding head 12.

Plate 38 is a circular disc. Plate 38 is further secured to threaded shaft 36 by way of a set screw (not shown) positioned transversely within a threaded hole (this threaded hole is shown in FIG. 7 as a vertical set of parallel lines in plate 38). Plate 38 and threaded shaft 36 thus move together longitudinally up and down, repeatedly, as inner shaft 24 rotates in one direction and then in the other direction. Plate 38 also includes two through-holes 44 through which two stationary posts 40 respectively extend (hole 44 in plate 38 of FIG. 7 can be designed to be radially inward as compared to how shown in FIG. 7, as necessary). FIG. 7 shows only one such through-hole 44 of plate 38, but it is understood that both holes 44 are substantially vertically aligned with the holes 46 of roller carrier 52 shown in FIGS. 2 and 4. Plate 38 is connected to cam system 54 by way of a plurality of bolts 56 through bolt holes 58 in plate 38 and a plurality of dowel pins (not shown) through dowel pin holes 60 in plate 38.

Cam system 54 includes a plurality of cam elements 54A, 54B, 54C, 54D. More specifically, the embodiment of the present invention which is shown in FIGS. 1-4 show that cam system 54 includes four cam elements 54A, 54B, 54C, 54D. Each cam element 54A, 54B, 54C, 54D is secured to plate 38 and thus is driven to move longitudinally up and down along with plate 38. The lower end of each cam element 54A, 54B, 54C, 54D includes one bolt hole 58 for receiving bolt 56, these bolts 56 attaching respective cam elements 54A, 54B, 54C, 54D to plate 38. Each cam element 54A, 54B, 54C, 54D also includes two dowel pin holes 60 for receiving the aforedescribed dowel pins (not shown), the dowel pins holding the location of the respective cam element 54A, 54B, 54C, 54D in position relative to plate 38. The upper end of each cam element 54A, 54B, 54C, 54D defines at least one generally Z-shaped cam track 62 which includes two parallel legs and a connecting leg which connects the two parallel legs together. The two parallel legs of cam track 62 are parallel to longitudinal axis 22 of winding head 12 and can be referred to as the radially outer leg and the radially inner leg. The radially outer leg is positioned higher than the radially inner leg. The connecting leg of cam track 62 forms a slanted angle with longitudinal axis 22. The four cam elements 54A, 54B, 54C, 54D are at least partly spaced apart from one another and are distributed circumferentially about plate 38. Cam track 62 can be formed as a shallow groove in a respective side of a respective cam element 54A, 54B, 54C, 54D. Each cam element 54A, 54B, 54C, 54D is connected to a pin 64 of at least one needle 20, pin 64 of needle 20 being positioned within cam track 62 of the respective cam element 54A, 54B, 54C, 54D and moving within cam track 62 as cam element 54A, 54B, 54C, 54D is moved up and down by plate 38.

As shown in FIGS. 2 and 4, cam system 54 includes two outside cam elements 54A, 54D and two inside cam elements 54B, 54C. Two cam elements 54A, 54B, 54C, 54D are assigned to each needle 20, each needle 20 being positioned in a space between adjacent cam elements 54A, 54B, 54C, 54D so that one end of pin 64 of a respective needle 20 is positioned within cam track 62 of one cam element 54A, 54B, 54C, 54D while the other end of pin 64 of the same needle 20 is positioned within cam track 62 of the adjacent cam element 54A, 54B, 54C, 54D. For example, the needle 20 at the seven o'clock position in FIGS. 2 and 4 includes a pin 64 which is positioned within cam track 62 of cam element 54A and also in cam track 62 of cam element 54B. FIGS. 2 and 4 show that each outside cam element 54A, 54D is assigned to only one needle 20 while each inside cam element 54B, 54C is assigned to two needles 20 each. Each outside cam element 54A, 54D includes only one cam track 62 positioned on the respective lateral side of outside cam elements 54A, 54D. Each inside cam element 54B, 54C includes two cam tracks 62, one cam track 62 on each lateral side of inside cam elements 54B, 54C. Thus, by way of cam system 54 moving up and down and by way of each Z-shaped cam track 62, each cam element 54A, 54B, 54C, 54D is configured for moving a respective needle 20 between a retracted position 66 and an extended position 68. More specifically, cam elements 54A, 54B, 54C, 54D respectively cooperate with each other to move needles 20. Each cam element 54A, 54B, 54C, 54D can be made of AISI M4 (which is a molybdenum high speed steel grade tool steel).

A lower sleeve 70 of winding head 12 slides over a portion of base 30, as shown in FIGS. 1, 3, and 7. Lower sleeve 70 houses various components of winding head 12 therein, such components including base 30, threaded shaft 36, plate 38, at least a portion of cam system 54, a portion of center tree 72, and two longitudinally extending posts 40. Lower sleeve 70 can be held in position relative to base 30 using a pin (not shown) to be placed in the U-shaped slot on the left end of lower sleeve 70 as oriented in FIG. 7 (actually, the bottom end of lower sleeve 70 in FIG. 1) and also into the hole in base in the top side of base 30 as oriented in FIG. 7 (actually, a longitudinal side of base 30 in FIG. 1). An upper sleeve 76 of winding head 12 interlocks with lower sleeve 70. Upper sleeve 76 also houses various components of winding head 12 therein, such components including at least a portion of center tree 72 and roller assembly 48. A spring housing cap 78 can be attached to the top of upper sleeve 76 by way of two bolts 80 screwed into the upper end of respective posts 40 (described more fully below). An upper cap 82 is fixed to the top of spring housing cap 78 by way of a plurality of screws 84.

Each of the two posts 40 has a lower end and an upper end. The lower end of each post 40 is threadably coupled to threaded hole 86 of base 30 and is thereby fixedly attached to base 30. Each post 40 is hollow and has a threaded bore therein. A threaded rod (not shown) is screwed to the lower end of each post 40, the threaded rod then being screwed into the threaded hole 86 of base 30. The upper end of each post 40 is threadably attached to a respective bolt 80, each bolt 80 extending down through spring housing cap 78, a respective hole 46 of a carrier 52 of roller assembly 48, and respective hole 90 of center tree 72 until the lower end of each bolt 80 is threadably received and thereby attached to the upper end of a respective post 40. The upper end of each post 40 abuts against a bottom surface of center tree 72, considering that the outside diameter of each post 40 is wider than the bolt through-holes 90 extending through center tree 72, center tree 72 thereby resting on the upper end of each post 40. Each post 40 also extends through a respective through-hole 44 of plate 38, these through-holes 44 providing a clearance for the posts 40 and thus not being fixedly attached to posts 40. Because posts 40 are fixedly attached as described, posts 40 prevent plate 38 from rotating when inner shaft 24 rotates. Posts 40 can be made of an A2 material and can be harder (or hardened to be harder) than the material of plate 38. Plate 38 can be made of a 4140 pre-hard material. Because plate 38 is fixedly attached to threaded shaft 36 and cam system 54, posts 40 also prevent threaded shaft 36 and cam system 54 from rotating when inner shaft 24 rotates.

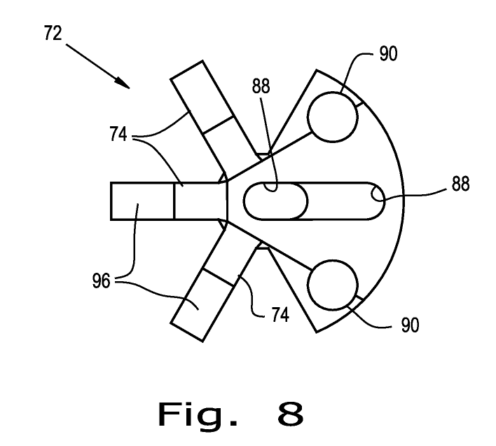

Center tree 72 is stationary within winding head 12 (but moves with winding head 12). Center tree 72 is held in place relative to upper and lower sleeves 70, 76 by way of being sandwiched between a bottom surface of roller assembly 48 and the top of the two posts 40. Center tree 72 includes a center through-bore 88 that can be shaped to pass therethrough three wires 14 for winding onto three separate teeth 18. Through-bore 88 has one wall that is substantially parallel to longitudinal axis and another wall which forms a slanted angle with longitudinal axis 22, this slanted wall accommodating a slant within the path of wires 14. The opening of through-bore 88 on the bottom of tree 72 is shown as a small oval in FIGS. 1-4 and 7-8; the opening of through-bore 88 on the top of tree 72 is shown as a large oval in FIGS. 1-4 and 7-8. One wire 14 is shown in FIGS. 1 and 3, it being understood that three wires 14 can simultaneously pass through through-bore 88, as shown in FIGS. 2 and 4 (FIGS. 2 and 4 show only one wire 14 winding around a tooth 18, but it is understood that each of wires 14 wind around a corresponding tooth 18). FIG. 8 shows that center tree 72 includes three wings 74 corresponding to three needles 20, each wing 74 being substantially identical to one another. Each wing 74 extends underneath a corresponding needle 20 and can extend into corresponding slots 92, 94 provided in lower sleeve and upper sleeve 70, 76. Wings 74 can rest within corresponding slots 92 of lower sleeve 70, for example, at the bottom of the slots 92 of lower sleeve 70 and be supported thereby. FIG. 7 shows three slots 92 of lower sleeve 70 which receive the three wings 74 of tree 72, the three slots 92 of lower sleeve 70 being aligned with the three longitudinal slots 94 of upper sleeve 76. Each wing 74 has an upwardly facing surface 96. Surface 96 runs from a high-point near the center of winding head 12 (when viewed from a top end of winding head 12) to a low-point at or near the outer surface of winding head 12. Each wing 74 is positioned between adjacent cam elements 54A, 54B, 54C, 54D. In this way, surfaces 96 of wings 74 can contact needles 20 respectively. Surface 96 has a first segment and a second segment. The first segment is slanted relative to longitudinal axis 22, the first segment running from the high-point. The second segment is generally perpendicular to longitudinal axis 22. Each surface 96 of wings 74 abuts against a corresponding needle 20 and thereby provides a guide surface for needle 20. Stated another way, center tree 72 is configured for guiding needle 20 between retracted position 66 and extended position 68. The first segment of wing 74, as needle 20 is pushed by biased keeper 98 and moved by cam element 54 through cam track 62, provides surface 96 for the proximal end of needle 20 to travel against until the proximal end of needle 20 reaches the second segment of wing 74. The second segment of wing 74 provides surface 96 that enables needle to straighten into extended position 68. Center tree 72 can be a micromelt Maxamelt alloy.

Roller assembly 48 is provided above center tree 72. Roller assembly 48 includes a roller 50 and a roller carrier 52 which carries roller 50. Each wire 14 proceeds up from the upper opening of center tree 72 and then runs over roller 50 of roller assembly 48 and then down to the corresponding needle 20. In this way, roller assembly 48 provides strain relief to each wire 14 so that wires 14 are not cut or damaged by an upper edge of tree 72 (if wire were to lay over that upper edge of tree 72 rather than over roller 50). Roller assembly 48 is sandwiched between an upper surface of center tree 72 and a lower surface of spring housing cap 78. Bolts 80 extend down through through-holes 46 of roller carrier 52, these bolts 80 being attached to posts 40. Roller 50 can include a bearing shaft extending through roller 50, a cylindrical bearing sleeve over which wires 14 proceed and surrounding the bearing shaft, a plurality of bearings spaced longitudinally along the bearing shaft and within the bearing sleeve, and a plurality of bearing spacers spaced longitudinally along the bearing shaft and within the bearing sleeve (the bearing spacers are positioned between the bearings); for example, three bearings and four bearing spacers therebetween can be used, or, alternatively, four bearings and three bearing spacers can be used, or, alternatively, any number of bearings and bearing spacers can be used. Both ends of the bearing shaft can be lightly peened to retain both ends of the bearing shaft within roller carrier 52 along the slanted walls of roller carrier 52 shown in FIGS. 2 and 4. FIGS. 2 and 4 show roller 50 including four vertical broken lines. The two inner vertical lines (which extend all the way to the edge of roller carrier 52) represent the bearing shaft. The left-most such broken line pairs with the left-nearest vertical solid line to represent one cross-sectional portion of the bearing sleeve, and the right-most such broken line pairs with the right-nearest vertical solid line to represent another cross-sectional portion of the bearing sleeve.

Because three needles 20 are used, winding head 12 includes three biased keepers 98, each keeper 98 being assigned to a particular needle 20. One keeper 98 is shown in the drawings, but it is understood that the keepers 98 are substantially identical to one another; thus, a description of one keeper 98 serves as a description of the other keepers 98. Keeper 98 is positioned generally above cam system 54, center tree 72, and needle 20. Keeper 98 is housed by upper sleeve 76 and spring housing cap 78. Keeper 98 is a pushing element which is assigned to a respective spring 100, spring 100 biasing keeper in the extended position (downward and thus towards needle 20 in FIGS. 1 and 3). Keeper 98 is thus a spring-loaded keeper. Keeper 98 is positioned generally within upper sleeve 76. Spring 100 is positioned within a generally circular shaped bore of spring housing cap 78, the lower end of this bore having a square or rectangular shape to accommodate a rectangular cross-section of keeper 98. The rear end of keeper 98 includes a depression for receiving spring 100 and being that in which spring 100 seats. Keeper 98 further includes a stepped segment (shown in FIG. 7, and also in FIGS. 1 and 3) which is positioned within a corresponding slot 94 of upper sleeve 76. Upper sleeve 76 includes three such slots 94 (as shown in FIG. 7) spaced about the circumference of upper sleeve 76 to accommodate three keepers 98. These slots 94 receive the corresponding stepped segments of the three keepers 98 and in which the stepped segments travel. Each keeper 98 includes a blind hole (shown in broken lines as a U-shaped element in FIG. 7 along the upper longitudinal side just to the right of the stepped portion of keeper 98) for receiving a pin (not shown) during maintenance; such a pin can be inserted through the three pin holes in upper sleeve 76 shown in FIG. 7 to the right of the longitudinal slots 94, the pin (one assigned to each keeper 98) being then further inserted into the blind hole of keeper 98 to secure keeper 98 in a raised position (for example, during maintenance). This action holds the corresponding keeper 98 so that keeper 98 and spring 100 do not fall downward out of position during maintenance and removal of needle 20. Thus, when the pin is not inserted, keeper 98 and spring 100 are sandwiched and thereby held longitudinally by way of spring housing cap 78, upper cap 82, and needle 20. When needle 20 is removed, keeper 98 would fall out of place if not for insertion of the pin (not shown) through the pin hole in upper sleeve 76 and into the blind hole in keeper 98. Keeper 98 is positioned generally in facing opposition to wing surface 96 of center tree 72 and between adjacent cam elements 54A, 54B, 54C, 54D. Keeper 98, by way of spring 100, provides a pushing force upon a top surface of needle 20, keeper 98 pushing needle 20 against wing surface 96 of center tree 72 and thereby forcing needle 20 to follow the path of wing surface 96 of tree 72. Keeper 98 is thus configured for holding needle 20 relative to center tree 72 through a full travel of needle 20 (such a full travel of needle 20 is shown in FIGS. 1, 3, and 5) between retracted position 66 and extended position 68.

Each needle 20 feeds, places, and thereby winds winding 14 (collectively the three wires 14) onto the stator teeth 18, as shown in FIGS. 2 and 4. While the winding head 12 of the present invention is described as including three needles 20, it is understood that the winding head 12 of the present invention could include only one such needle 20, two needles 20, three needles 20, or more needles 20. Each needle 20 is substantially identical to one another; thus, a description of one needle 20 serves as a description of the other needles 20. The three needles 20 are positioned sixty degrees apart from one another about longitudinal axis, as shown in FIGS. 2 and 4 and as indicated by slots 92, and 94 in FIG. 7. Needle 20 is positionable between retracted position 66 and extended position 68. Retracted position 66 is oriented generally axially relative to longitudinal axis 22 of winding head 12; as shown in FIG. 1, in retracted position 66 needle 20 can form a slant relative to longitudinal axis 22. Extended position 68 is oriented generally radially relative to longitudinal axis 22; as shown in FIG. 3, in extended position 66 needle 20 is substantially perpendicular to longitudinal axis 22.

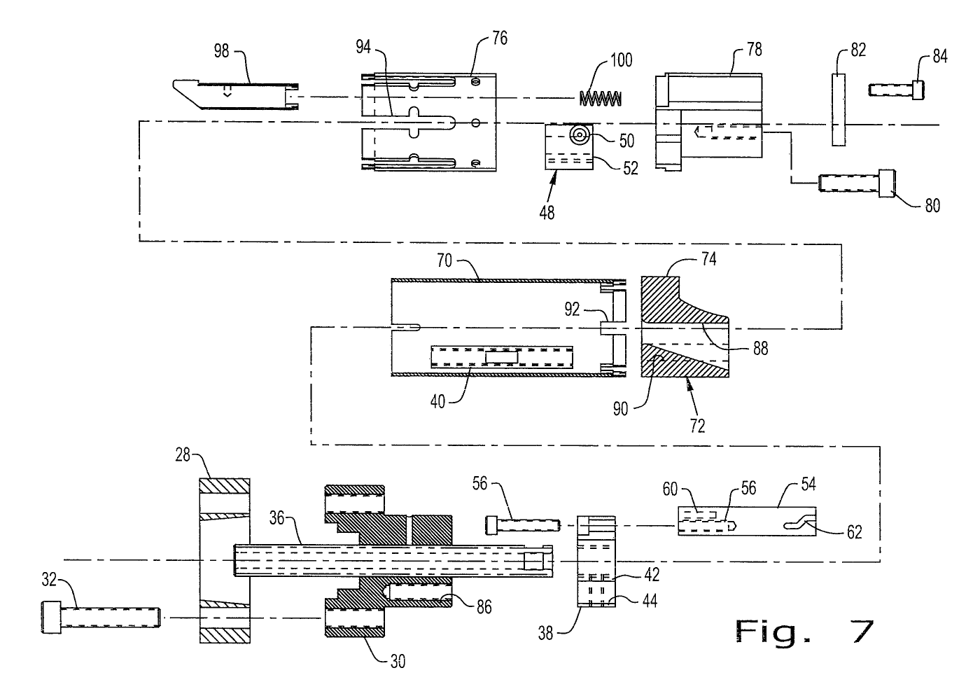

Needle 20 includes a proximal end, a distal end, and a pin 64. In FIG. 5, the proximal end is shown to the right of needle 20, and the distal end is shown to the left of needle 20 (the distal end being the free end of needle 20). The proximal end includes pin 64 extending transversely through and beyond both longitudinal sides of needle 20. Needle 20 also includes a longitudinal bore 102 (shown in FIG. 6) running therethrough, a respective wire 14 running all of the way through bore 102 from the proximal end to the distal end of needle 20. Wire 14 proceeds from the distal end to be wound around a corresponding tooth 18 of stator 16. Bore 102 is formed by drilling. Pin 64 travels within Z-shaped cam tracks 62 of two adjacent cam elements 54A, 54B, 54C, 54D as cam elements 54A, 54B, 54C, 54D are moved up and down. As shown in FIGS. 3 and 4, pin 64 is positioned within the radially outer leg of Z-shaped cam track 62 when cam elements 54A, 54B, 54C, 54D are in a down position. Needle 20 is thus in extended position 68 when cam elements 54A, 54B, 54C, 54D are in the down position, as shown in FIGS. 3 and 4. As shown in FIGS. 1 and 2, pin 64 is positioned within the radially inner leg of Z-shaped cam track 62 when cam elements 54A, 54B, 54C, 54D are in an up position. Needle 20 is thus in retracted position 66 when cam elements 54A, 54B, 54C, 54D are in the up position, as shown in FIGS. 1 and 2. Between the up and down positions of cam elements 54A, 54B, 54C, 54D, pin 64 travels in the connecting leg of Z-shaped cam track 62. In retracted position 66, the distal end of pin 64 is still positioned beyond the outer radial surface of the upper sleeve 76, as shown in FIGS. 1 and 2. This enables needle 20 to wind wire 14 on a stator tooth 16 even in the retracted position 66. In extended position 68, the distal end of needle 20 extends its farthest distance from the outer surface of winding head 12, considering that needle 20 is in extended position 68 and that pin 64 is positioned in the radially outer leg of Z-shaped cam track 62. As cam elements 54A, 54B, 54C, 54D move from the up position to the down position, the body of needle 20 is sandwiched between a respective wing 74 of center tree 72 and keeper 98. More specifically, a bottom surface of needle 20 travels along surface 96 of a respective wing 74, while a top surface of needle 20 is pushed by keeper 98. As needle 20 reaches the second segment of center tree 72, needle 20 turns and is directed radially outwardly relative to longitudinal axis 22. FIG. 5 shows needle 20 in retracted and extended positions 66, 68, as well as in intermediate positions along the full travel path of needle 20. Needle 20 can be made of tool steel. During maintenance, needle 20 can be removed through a corresponding longitudinal slot 94 of upper sleeve 76, pin 64 being removed through the transverse slot crossing the corresponding longitudinal slot 94 (the transverse slot being shown in FIG. 7) as the body of needle 20 is removed through longitudinal slot 94.

In use, winding machine 10 moves winding head 12 repeatedly up and down in the longitudinal direction (which corresponds with longitudinal axis 22). Winding machine 10 also repeatedly partially rotates winding head 12 clockwise and counter-clockwise about longitudinal axis 22 viewing winding head 12 from above as in FIGS. 2 and 4. This movement of winding head 12 up and down and clockwise and counter-clockwise allows needle 20 to complete a full turn around a respective tooth 18 of stator 16 in selectively either the clockwise direction or the counter-clockwise direction when viewing tooth 18 from longitudinal axis 22 of winding head 12. When three needles 20 are used, three wires 14 are used to wind around three separate teeth 18 of stator 16, each wire 14 being assigned to a respective tooth 18. The respective wire path of wire 14 runs from a spool (not shown) of wire 14 and eventually through the bores of inner shaft 24, threaded shaft 36, and center tree 72. Wire 14 then travels over roller 50 and then down into bore 102 of the respective needle 20, running from the proximal end to the distal end of needle 20. The free end of wire 14 can be held by a wire handler of winding machine 10 under stator 16. As winding head 12 moves up and down and rotates around the respective tooth 18 of stator 16, needle 20 lays the corresponding wire 14 on tooth 18 and wraps wire 14 around tooth 18. When needle 20 is in extended position 68, needle 20 is able to wrap wire 14 around the base of tooth 18 (the portion of tooth 18 connecting to the rest of stator 16. When needle 20 is at or near retracted position 66, needle 20 is able to wrap wire 14 around the free end of tooth 18. Thus, as needle 20 moves between the extended and retracted positions 66, 68, needle 20 is able to wrap wire 14 around tooth 18 at least substantially along the entire length of tooth 18. With three needles 20, winding head 12 can thus simultaneously wind wire 14 around three separate teeth 18 in a similar manner as described. As threaded shaft 36 moves to its up position, plate 38 and thus cam system 54 move to their up positions as well. In so doing, pin 64 of needle 20 slides in cam track 62 to the radially inner leg of cam track 62, needle 20 moving along surface 96 of tree 72 as keeper 98 pushes on needle 20, needle 20 moving to retracted position 66. As threaded shaft 36 moves to its down position, plate 38 and thus cam system 54 move to their down positions as well. In so doing, pin 64 of needle 20 slides in cam track 62 to the radially out leg of cam track 62, needle 20 moving along surface 96 of tree 72 as keeper 98 pushes on needle 20, needle 20 moving to extended position 68. Thus, when inner shaft 24 rotates, threaded shaft 36 moves up. Threaded shaft 36 is connected to a series of cam elements 54A, 54B, 54C, 54D which moves up with threaded shaft 36. When cam elements 54A, 54B, 54C, 54D (which also can be referred to as a cam driver) moves up, cam elements 54A, 54B, 54C, 54D push pins 64 in needles 20, which pushes needles 20 up and to the inside diameter of winding head 12. The back (proximal end) of needles 20 are guided by center tree 72. Needles 20 are held in position through the full travel by spring-loaded keepers 98. Wires 14 are shown in FIGS. 1-4, their wire paths being indicated thereby. When inner shaft 24 rotates in the opposite direction, the movements are reversed and needles 20 travel to the out position (extended position 68). Winding head 12 can be lubricated prior to use, but thereafter no lubrication may be necessary in view of dissimilar materials being used.

The present invention further provides a method of using winding machine 10 for winding 14 of stator 16. The method includes the steps of: providing winding head 12 including at least one movable needle 20; and positioning at least one movable needle 20 between a retracted position 66 and an extended position 68, retracted position 66 being oriented generally axially relative to longitudinal axis 22 of winding head 12, extended position 68 being oriented generally radially relative to longitudinal axis 22. Three movable needles 20 can be provided. Needle 20 includes a proximal end with pin 64, winding head 12 including cam element 54A, 54B, 54C, 54D connected to pin 64, the method further including moving needle 20 using cam element 54A, 54B, 54C, 54D between retracted and extended positions 66, 68. Winding head 12 includes center tree 72, the method further including guiding needle 20 between retracted and extended positions 66, 68. Winding head 12 includes a biased keeper 98, the method further including holding needle 20 relative to center tree 72 using biased keeper 98 through a full travel between retracted and extended positions 66, 68.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An in-slot winding machine for winding a winding of a stator, said in-slot winding machine comprising:
a winding head including at least one movable needle which is positionable between a retracted position and an extended position, said retracted position being oriented generally axially relative to a longitudinal axis of said winding head, said extended position being oriented generally radially relative to said longitudinal axis.

2. The in-slot winding machine according to claim 1, wherein said at least one movable needle includes three of said movable needle.

3. The in-slot winding machine according to claim 1, wherein said needle includes a proximal end with a pin, said winding head including a cam element connected to said pin, said cam element being configured for moving said needle between said retracted and extended positions.

4. The in-slot winding machine according to claim 3, wherein said winding head includes a center tree configured for guiding said needle between said retracted and extended positions.

5. The in-slot winding machine according to claim 4, wherein said winding head includes a biased keeper configured for holding said needle relative to said center tree through a full travel between said retracted and extended positions.

6. A winding head of an in-slot winding machine for winding a winding of a stator, said winding head comprising:
at least one movable needle which is positionable between a retracted position and an extended position, said retracted position being oriented generally axially relative to a longitudinal axis of the winding head, said extended position being oriented generally radially relative to said longitudinal axis.

7. The winding head according to claim 6, wherein said at least one movable needle includes three of said movable needle.

8. The winding head according to claim 6, wherein said needle includes a proximal end with a pin, the winding head further including a cam element connected to said pin, said cam element being configured for moving said needle between said retracted and extended positions.

9. The winding head according to claim 8, further including a center tree configured for guiding said needle between said retracted and extended positions.

10. The winding head according to claim 9, further including a biased keeper configured for holding said needle relative to said center tree through a full travel between said retracted and extended positions.

11. A method of using a winding machine for winding a winding of a stator, said method comprising the steps of:
providing a winding head including at least one movable needle; and
positioning said at least one movable needle between a retracted position and an extended position, said retracted position being oriented generally axially relative to a longitudinal axis of said winding head, said extended position being oriented generally radially relative to said longitudinal axis.

12. The method according to claim 11, wherein said at least one movable needle includes three of said movable needle.

13. The method according to claim 11, wherein said needle includes a proximal end with a pin, said winding head including a cam element connected to said pin, the method further including moving said needle using said cam element between said retracted and extended positions.

14. The method according to claim 13, wherein said winding head includes a center tree, the method further including guiding said needle between said retracted and extended positions.

15. The method according to claim 14, wherein said winding head includes a biased keeper, the method further including holding said needle relative to said center tree using said biased keeper through a full travel between said retracted and extended positions.
